(19) United States
(12) Patent Application Publication
(10) Pub. No.: US 2018/0032067 A1
(43) Pub. Date: Feb. 1, 2018

(54) NUMERICAL CONTROLLER

(71) Applicant: FANUC CORPORATION, Minamitsuru-gun (JP)

(72) Inventor: Kouji Maeda, Minamitsuru-gun (JP)

(73) Assignee: FANUC CORPORATION, Minamitsuru-gun (JP)

(21) Appl. No.: 15/656,100

(22) Filed: Jul. 21, 2017

(30) Foreign Application Priority Data
Jul. 27, 2016 (JP) 2016-147280

(51) Int. Cl. G05B 23/02

(52) U.S. Cl. CPC G05B 23/0221

(57) ABSTRACT

A numerical controller capable of suppressing a load on monitoring processing by monitoring only necessary items according to the operation state of a machine tool or the like includes a monitoring pattern storage unit loaded with a monitoring pattern defined for each operation state of the device to be monitored, a determination unit configured to determine the operation state of the device to be monitored, a monitoring pattern selection unit configured to acquire the monitoring pattern corresponding to the determined operation state from the monitoring pattern storage unit and create a monitoring list based on the acquired monitoring pattern, and a monitoring unit configured to monitor the device to be monitored based on the monitoring list and acquire the monitoring data.

### BACKGROUND OF THE INVENTION

### Field of the Invention

The present invention relates to a numerical controller, and more particularly, to a technique for monitoring the state of a machine tool or the like.

### Description of the Related Art

There is known a numerical controller that monitors the operation state of a machine tool, robot, any other production facility and/or the like (hereinafter referred to as “machine tool and/or the like”) in order to manage and analyze the operation of the machine tool and/or the like. In general, items to be monitored vary depending on the operation mode, operating time and other conditions of the machine tool and/or the like, so that they cover a wide range. On the other hand, hardware resources (e.g., CPU and storage memory) of the numerical controller are limited. Therefore, it is technically difficult to monitor a large number of items for a long period of time or store the results of monitoring.

In this regard, Japanese Patent Application Laid-Open No. 2007-004601 describes a technique in which the storage capacity for monitoring data is minimized so that data processing and the like can easily be performed despite limited hardware resources.

Japanese Patent Application Laid-Open No. 2005-277863 describes a monitoring control device configured to vary the monitoring period according to the CPU load, that is, perform thinned monitoring.

Japanese Patent Application Laid-Open No. 2005-011203 describes a numerical controller capable of acquiring machining state information on necessary spots even with a small memory capacity by acquiring machining states with sampling spots and sampling periods specified in an NC program.

Japanese Patent Application Laid-Open No. 2001-014008 describes a control device capable of acquiring and transmitting data such as the operating status of a PLC with a predetermined timing and period.

According to the technique described in Japanese Patent Application Laid-Open No. 2007-004601, however, the CPU load during monitoring cannot be reduced, although the storage capacity for the monitoring data can be reduced. The technique described in Japanese Patent Application Laid-Open No. 2005-277863 has problems that the monitoring period inevitably varies depending on the CPU load on the side of the monitoring control device (equivalent to a numerical controller). The technique described in Japanese Patent Application Laid-Open No. 2005-011203 has problems that monitoring cannot be performed while the machine tool or the like is not being operated and that the monitoring item cannot be dynamically changed according to the operation state of the machine tool or the like. Moreover, the technique of Japanese Patent Application Laid-Open No. 2001-014008 has problems that the monitoring period cannot be dynamically changed according to the operation state of the machine tool or the like.

### SUMMARY OF THE INVENTION

The present invention has been made to solve the above problems, and its object is to provide a numerical controller capable of suppressing a load on monitoring processing by monitoring only necessary items according to the operation state of a machine tool or the like.

A numerical controller according to one embodiment of the present invention is a numerical controller configured to monitor a device to be monitored and acquire monitoring data and comprising a monitoring pattern storage unit loaded with a monitoring pattern defined for each operation state of the device to be monitored, a determination unit configured to determine the operation state of the device to be monitored, acquire the monitoring pattern corresponding to the determined operation state from the monitoring pattern storage unit, and create a monitoring list based on the acquired monitoring pattern, and a monitoring unit configured to monitor the device to be monitored based on the monitoring list and acquire the monitoring data.

In a numerical controller according to another embodiment of the present invention, the monitoring pattern contains one or more monitoring items and monitoring periods for the individual monitoring items, and the monitoring unit monitors the monitoring items at the monitoring periods.

In a numerical controller according to another embodiment of the present invention, the determination unit acquires a plurality of the monitoring patterns corresponding to the determined operation state from the monitoring pattern storage unit and creates the monitoring list by combining the plurality of the monitoring patterns.

In a numerical controller according to another embodiment of the present invention, the determination unit updates the monitoring list when the operation state is changed.

In a numerical controller according to another embodiment of the present invention, the determination unit updates the monitoring list at regular time intervals.

According to the present invention, there can be provided a numerical controller capable of suppressing a load on monitoring processing by monitoring only necessary items according to the operation state of a machine tool or the like.

### BRIEF DESCRIPTION OF THE DRAWINGS

The above and other objects and features of the present invention will be obvious from the ensuing description of embodiments with reference to the accompanying drawings, in which:

FIG. 1 is a diagram showing an outline of a numerical controller according to the present invention;

FIG. 2 is a diagram showing the configuration of a numerical controller according to an embodiment of the present invention;

FIG. 3 is a diagram showing an example of a monitoring pattern in the embodiment of the present invention;

FIG. 4 is a diagram showing an example of the monitoring pattern in the embodiment of the present invention;

FIG. 5 is a diagram showing an example of the monitoring pattern in the embodiment of the present invention;

FIG. 6 is a diagram showing an example of the monitoring pattern in the embodiment of the present invention;

FIG. 7 is a diagram showing an example of the monitoring pattern in the embodiment of the present invention;

FIG. 8 is a diagram showing the operation of a numerical controller 100 according to Embodiment 1 of the present invention; and

FIG. 9 is a diagram showing the operation of a numerical controller 100 according to Embodiment 2 of the present invention.

### DETAILED DESCRIPTION OF THE PREFERRED EMBODIMENTS

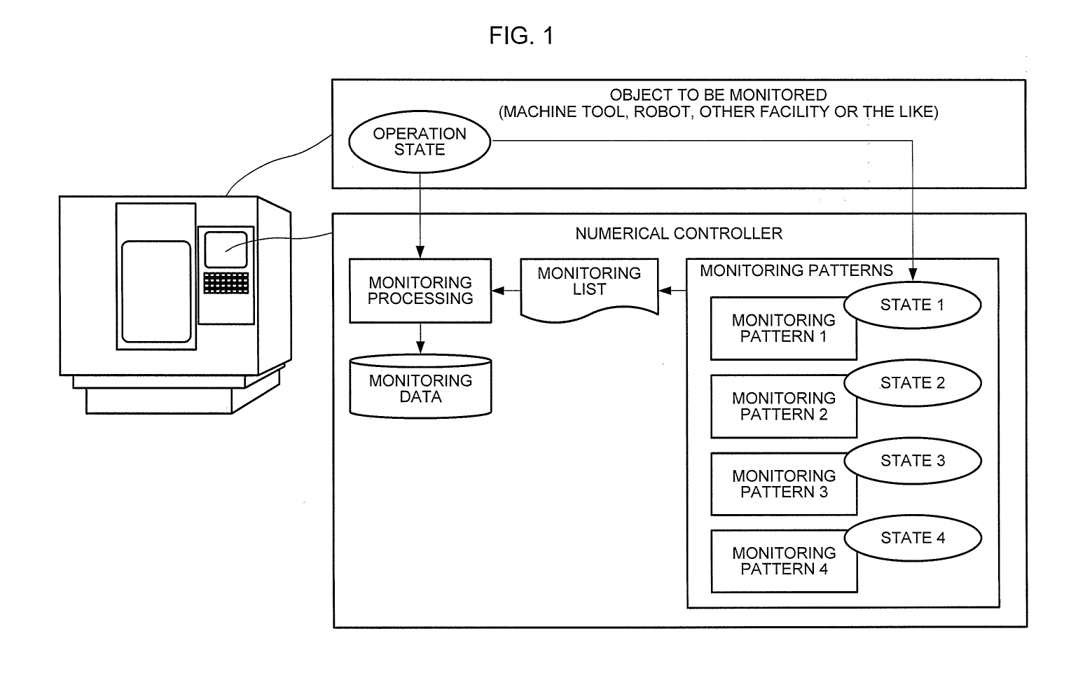

First, an outline of the present invention will be described with reference to FIG. 1. A numerical controller according to the present invention is designed for a machine tool and the like as objects of monitoring. It is characterized by varying monitoring items and monitoring periods based on the operation states of the machine tool and the like. In order to realize this, the numerical controller previously keeps a corresponding monitoring pattern for each operation state of the machine tool or the like. Here the operation state is information indicative of the current operating situation of the machine tool or the like and is defined by, for example, an operation mode, elapsed time after startup, running operation program or the like or a combination of these items. The monitoring pattern is typically a data set that associates one or more monitoring items and monitoring periods set for the individual monitoring items. The monitoring item is information that can be acquired from the machine tool or the like and is conducive to operation management, analysis and the like of the machine tool or the like. The monitoring period is a time interval for repeated acquisition of the information on the monitoring items by the numerical controller.

The numerical controller first constantly monitors the operation state of the machine tool or the like. Then, it determines a monitoring pattern corresponding to the recognized operation state. The numerical controller creates a monitoring list based on the identified monitoring pattern. The monitoring is continued based on the created monitoring list.

The numerical controller updates, that is, re-creates a monitoring list corresponding to a new operation state, triggered by a change, if any, of the operation state of the machine tool or the like. Alternatively, the numerical controller may be configured to update the monitoring list at regular time intervals, for example, without requiring any special trigger.

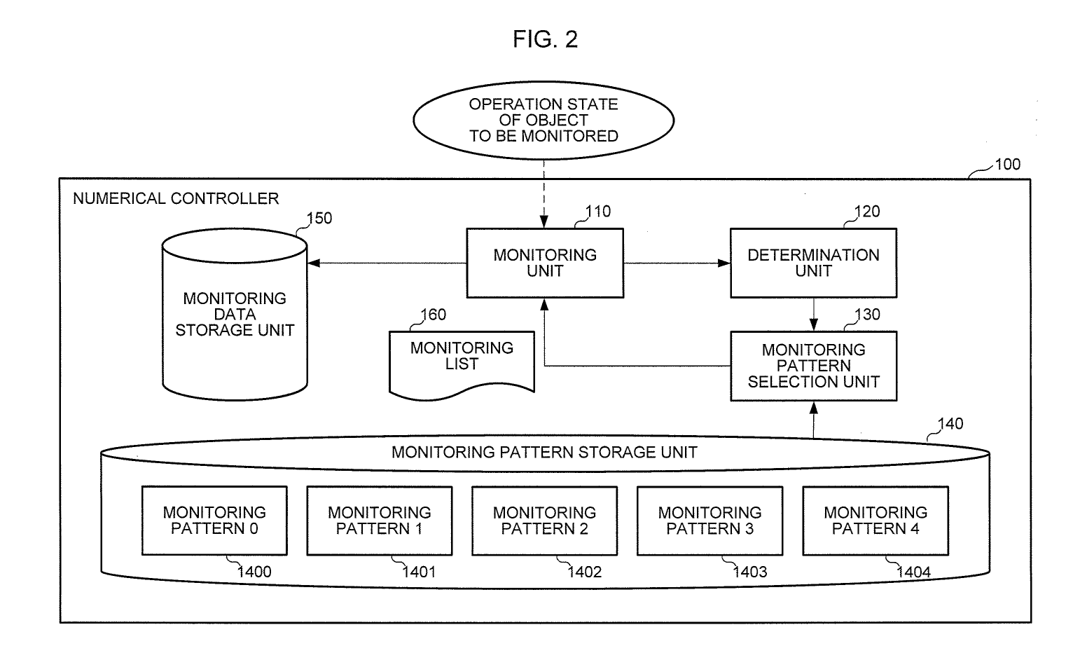

Specific embodiments of the present invention will now be described with reference to FIGS. 2 to 9. First, an example in which the monitoring list is updated when the operation state of the machine tool or the like is changed will be described as Embodiment 1. Then, an example in which the monitoring list is updated at regular time intervals will be described as Embodiment 2.

### Embodiment 1

The configuration of Embodiment 1 of the present invention will be described with reference to the block diagram of FIG. 2.

A numerical controller 100 according to Embodiment 1 of the present invention comprises a monitoring unit 110, determination unit 120, monitoring pattern selection unit 130, monitoring pattern storage unit 140, and monitoring data storage unit 150. Typically, the numerical controller 100 is typically an information processor comprising a central processing unit, storage device, and input/output device. As the central processing unit executes a program stored in the storage device, the functions of the above processing parts are logically implemented. Moreover, the numerical controller 100 is connected to a machine tool or the like (not shown) for communication such that it can acquire information for determining the operation state and information related to the monitoring items from the machine tool or the like.

The monitoring unit 110 acquires the information (hereinafter referred to as monitoring data) related to the monitoring items enumerated on a monitoring list 160. Moreover, the monitoring unit 110 loads the acquired monitoring data into the monitoring data storage unit 150.

The determination unit 120 determines the operation state of the machine tool or the like based on the monitoring data acquired from the machine tool or the like.

The monitoring pattern selection unit 130 acquires one or more monitoring patterns corresponding to the operation state of the machine tool or the like determined by the determination unit 120 from the monitoring pattern storage unit 140 and creates the monitoring list 160.

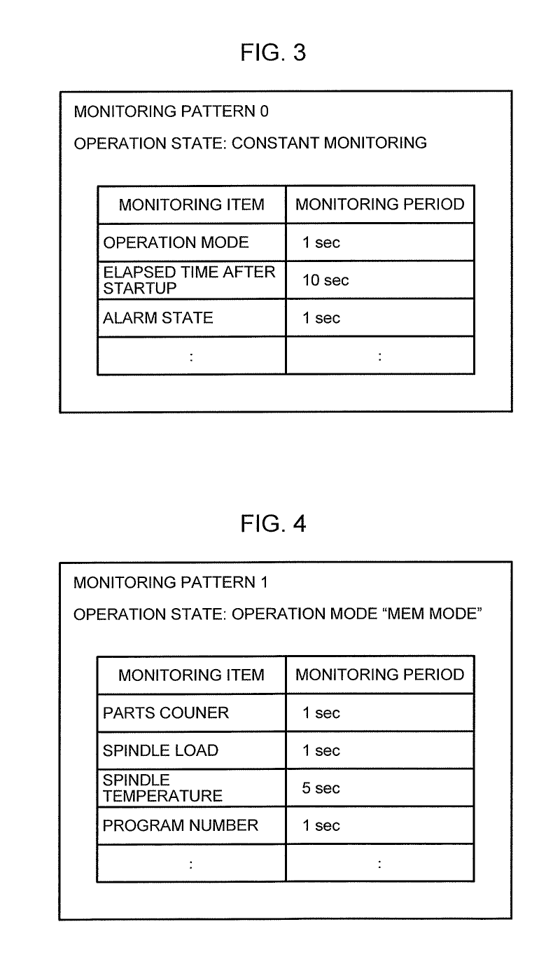

The monitoring pattern storage unit 140 is correspondingly loaded with the operation state of the machine tool or the like and the monitoring patterns. Each monitoring pattern typically contains one or more monitoring items and monitoring periods set for the individual monitoring items. FIGS. 3 to 7 show examples of the monitoring pattern.

In a monitoring pattern 0 (FIG. 3), “constant monitoring” is set as the operation state. The numerical controller 100 always uses this monitoring pattern without regard to the operation state of the machine tool or the like. In this monitoring pattern, an “operation mode”, “elapsed time after startup”, and “alarm state” are defined as the monitoring items, and “1 sec”, “10 sec” and “1 sec” are defined individually as the monitoring periods. When this monitoring pattern is applied, the numerical controller 100 acquires the “operation mode”, “elapsed time after startup”, and “alarm state” with the periods “1 sec”, “10 sec” and “1 sec”, respectively.

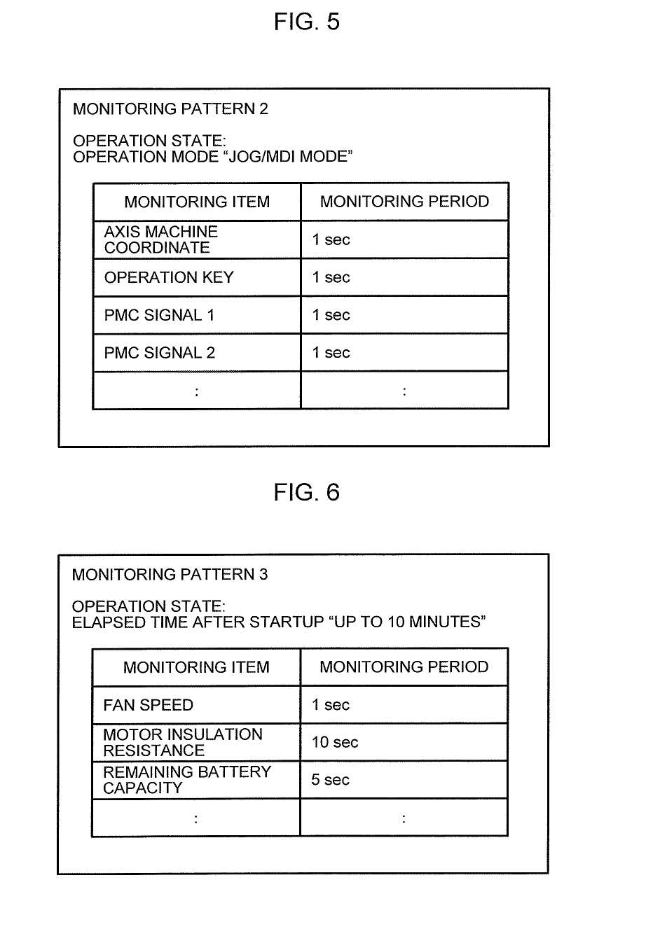

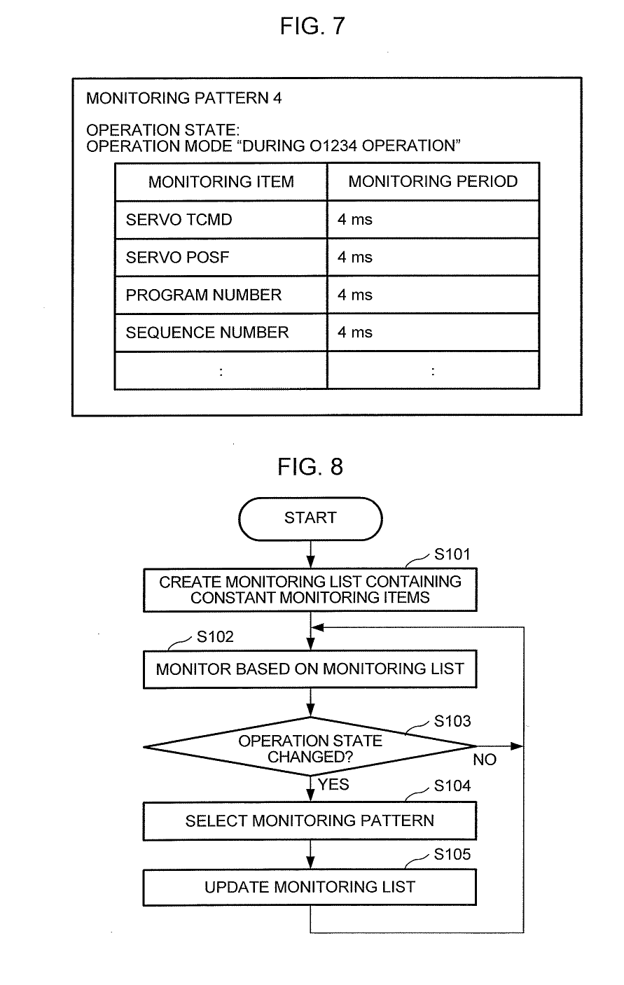

An “operation mode: MEM mode”, “operation mode: JOG/MDI mode”, “elapsed time after startup: up to 10 minutes”, and “operation mode: during O1234 operation” are set as operation states in a monitoring pattern 1 (FIG. 4), monitoring pattern 2 (FIG. 5), monitoring pattern 3 (FIG. 6), and monitoring pattern 4 (FIG. 7), respectively. The numerical controller 100 uses the monitoring pattern 1 when the operation mode of the machine tool or the like is the “MEM mode”. Moreover, the numerical controller 100 uses the monitoring pattern 2 when the operation mode is the “JOG/MDI mode”; monitoring pattern 3 when the elapsed time after startup is “up to 10 minutes”, and monitoring pattern 4 when the operation mode is “during O1234 operation”.

If the operation state of the machine tool or the like matches a plurality of monitoring patterns, the numerical controller 100 may use those monitoring patterns in a superposed manner. More specifically, the monitoring pattern selection unit 130 can acquire a plurality of monitoring patterns compatible with the operation state from the monitoring pattern storage unit 140 and combine or merge them into a single monitoring list.

The operation of the numerical controller 100 according to Embodiment 1 will now be described with reference to the flowchart of FIG. 8.

S101:

The monitoring pattern selection unit 130 creates the monitoring list. The monitoring list is a list on which items to be monitored by the monitoring unit 110 are enumerated and that typically contains one or more monitoring items and monitoring periods corresponding thereto.

The monitoring pattern selection unit 130 creates a first monitoring list in this step. This monitoring list contains at least those monitoring items which are to be constantly monitored. Specifically, the monitoring list is created using monitoring items and monitoring periods contained in that acquired monitoring pattern in which, among the other monitoring patterns stored in the monitoring pattern storage unit 140, the “constant monitoring” is set as the operation state. In the present embodiment, the monitoring pattern 0 (FIG. 3) is the monitoring pattern for the “constant monitoring”. Thus, the monitoring pattern selection unit 130 creates the monitoring list with the same content as the monitoring items and monitoring periods of the monitoring pattern 0.

S102:

The monitoring unit 110 communicates with the machine tool or the like to monitor the monitoring items enumerated in the monitoring list with monitoring periods associated individually with the monitoring items. For example, if the monitoring item and the monitoring period are the “operation mode” and “1 sec”, respectively, the monitoring unit 110 communicates with the machine tool or the like with every one second to acquire the current “operation mode” of the machine tool or the like as the monitoring data.

The monitoring unit 110 loads the acquired monitoring data into the monitoring data storage unit 150.

S103:

The determination unit 120 determines the current operation state based on the monitoring data acquired in Step S102. In general, the operation state is determined based on monitoring items contained in the monitoring pattern for the “constant monitoring”. In the present embodiment, the determination unit 120 is assumed to determine the operation state based on the monitoring items “operation mode” and “elapsed time after startup” contained in the monitoring pattern 0 (FIG. 3).

For example, if the machine tool or the like starts operation in the “MEM mode” and if monitoring data is acquired such that the monitoring data “MEM mode” and “15 sec” are acquired as the “operation mode” and the “elapsed time after startup”, respectively, in Step S102, the determination unit 120 determines a combination of these data to be the current operation state.

If the determined operation state is regarded as being different from the immediately preceding operation state, the monitoring pattern selection unit 130 proceeds to Step S104 and updates the monitoring list. If the determined operation state is regarded as being identical to the immediately preceding operation state, in contrast, the monitoring pattern selection unit 130 need not update the monitoring list. In the latter case, the processing returns to Step S102, in which the monitoring is continued using the previous monitoring list.

For example, if the “elapsed time after startup” acquired this time and the previously acquired “elapsed time after startup” are “15 sec” and “5 sec”, respectively, both these times may be regarded as identical. This is because either of the elapsed times after startup is within 10 minutes and the same monitoring pattern 3 (FIG. 6) is used.

S104:

The monitoring pattern selection unit 130 acquires a monitoring pattern corresponding to the operation state determined in Step S103 from the monitoring pattern storage unit 140. The monitoring pattern corresponding to the operation state is not always limited to one in number. In this case, the monitoring pattern selection unit 130 may acquire a plurality of monitoring patterns corresponding to the operation state.

If it is determined, for example, that the “operation mode” and the “elapsed time after startup” are the “MEM mode” and “15 sec”, respectively, as the current operation state, the monitoring pattern selection unit 130 acquires the monitoring pattern 0 (FIG. 3) in which the operation state is defined as the “constant monitoring”, the monitoring pattern 1 (FIG. 4) in which the operation state is defined as the “MEM mode”, and the monitoring pattern 3 (FIG. 6) in which the elapsed time after startup is defined as “up to 10 minutes”, from the monitoring pattern storage unit 140.

S105:

The monitoring pattern selection unit 130 newly creates all the monitoring items contained in the one or more monitoring patterns acquired in Step S104 and a monitoring list that contains their monitoring periods. In other words, the monitoring pattern selection unit 130 merges the monitoring items of all the acquired monitoring patterns and their monitoring periods, thereby updating the monitoring list.

Thereafter, the processing returns to S102, in which monitoring unit 110 continues the monitoring using the updated monitoring list.

### Embodiment 2

A numerical controller 100 according to Embodiment 2 of the present invention has the same construction as that of Embodiment 1 (see FIG. 2).

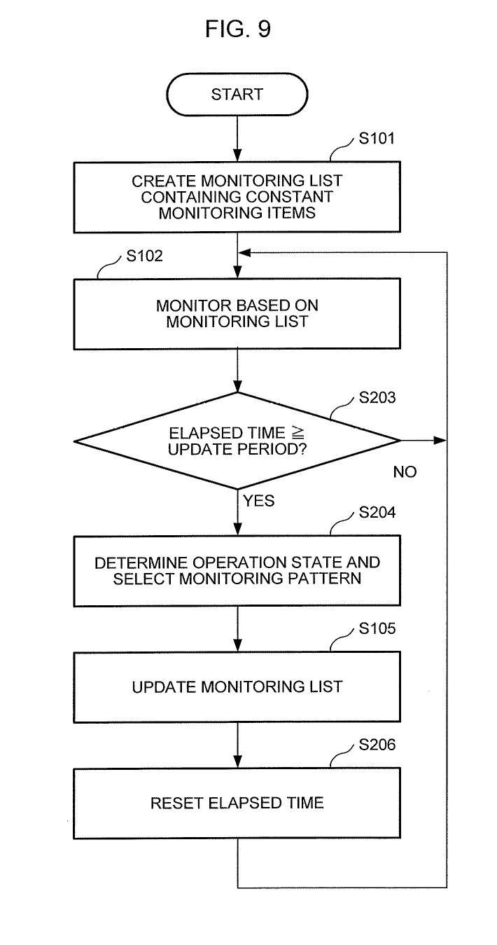

The operation of the numerical controller 100 according to Embodiment 2 of the present invention will be described with reference to the flowchart of FIG. 9. Since the steps of processing of the present embodiment and Embodiment 2 (FIG. 8) designated by like step numbers share the content, descriptions thereof will be suitably omitted.

S101:

A determination unit 120 creates a monitoring list containing constant monitoring items.

S102:

A monitoring unit 110 communicates with a machine tool or the like to acquire monitoring data based on monitoring items and monitoring periods specified in a monitoring list. The monitoring unit 110 loads the acquired monitoring data into a monitoring data storage unit 150.

S203:

The determination unit 120 determines whether or not a predetermined update period is exceeded by the elapsed time. Typically, the determination unit activates a timer in starting the processing of Step S101 and measures the time elapsed from the activation of the timer. The update period is previously loaded into a storage area (not shown), and the determination unit 120 acquires the update period with reference to this storage area.

If the update period is exceeded by the elapsed time, the processing proceeds to Step S204. If not, the processing returns to Step S102, in which the monitoring unit 110 continues the monitoring using the previous monitoring list.

S204:

The determination unit 120 determines the current operation state based on the monitoring data acquired in Step S102, and a monitoring pattern selection unit 130 acquires the monitoring pattern corresponding to the determined operation state from a monitoring pattern storage unit 140. The processing for determining the operation state and the processing for acquiring the monitoring pattern can be carried out in the same manner as in Steps S103 and S104 of Embodiment 1.

S105:

The monitoring pattern selection unit 130 updates the monitoring list based on the monitoring pattern acquired in Step S204.

S206:

The determination unit 120 resets the elapsed time. Specifically, it sets the timer to 0 and resumes the measurement of the elapsed time.

According to the embodiments described above, the numerical controller 100 can monitor only the then required monitoring items with an appropriate monitoring period according to the operation state of the machine tool or the like. Thus, the possibility of useless monitoring can be eliminated, so that the processing load of the numerical controller 100 can be reduced. Moreover, the volume of the monitoring data loaded into the monitoring data storage unit 150 can be suppressed. Furthermore, the processing load of the machine tool or the like is also reduced, so that the performance of the entire system can be prevented from being reduced by the monitoring processing.

The present invention is not limited to the above-described embodiments and may be suitably changed without departing from the spirit of the invention. Any of the constituent elements of the embodiments may be modified or omitted without departing from the scope of the invention.

Although the determination unit 120 determines the operation state using the monitoring pattern 0 defined as the “constant monitoring” in the embodiments described above, for example, the present invention is not limited to this. For example, the operation state of the machine tool or the like can be determined without using the monitoring pattern 0 by previously holding monitoring items for determining the operation state.

Furthermore, although the monitoring pattern selection unit 130 acquires all the monitoring patterns compatible with the current operation state and creates the monitoring list by merging their contents in the embodiments described above, the present invention is not limited to this. For example, the Monitoring pattern selection unit 130 can select the monitoring pattern to create the monitoring list using only the selected monitoring pattern in such a manner that a plurality of monitoring patterns are given priority in advance or that the monitoring pattern selection unit 130 has a logic for determining the priority of the monitoring patterns.

Moreover, although the numerical controller 100 is illustrated as comprising the monitoring data storage unit 150 in the embodiments described above, the present invention is not limited to this. The monitoring data storage unit 150 may be provided outside the numerical controller 100.

Furthermore, although the example in which the monitoring pattern selection unit 130 updates the monitoring list triggered by a change of the operation state and the example in which the monitoring list is updated at a constant period are illustrated in the embodiments described above, the present invention is not limited to this. The monitoring pattern selection unit 130 can update the monitoring list triggered in any other way.

1. A numerical controller configured to monitor a device to be monitored and acquire monitoring data, comprising:
a monitoring pattern storage unit loaded with a monitoring pattern defined for each operation state of the device to be monitored;
a determination unit configured to determine the operation state of the device to be monitored, acquire the monitoring pattern corresponding to the determined operation state from the monitoring pattern storage unit, and create a monitoring list based on the acquired monitoring pattern; and
a monitoring unit configured to monitor the device to be monitored based on the monitoring list and acquire the monitoring data.

2. The numerical controller according to claim 1, wherein the monitoring pattern contains one or more monitoring items and monitoring periods for the individual monitoring items, and the monitoring unit monitors the monitoring items at the monitoring periods.

3. The numerical controller according to claim 1, wherein the determination unit acquires a plurality of the monitoring patterns corresponding to the determined operation state from the monitoring pattern storage unit and creates the monitoring list by combining the plurality of the monitoring patterns.

4. The numerical controller according to claim 1, wherein the determination unit updates the monitoring list when the operation state is changed.

5. The numerical controller according to claim 1, wherein the determination unit updates the monitoring list at regular time intervals.
